(19) United States
(12) Patent Application Publication
(10) Pub. No.: US 2026/0066740 A1
(43) Pub. Date: Mar. 5, 2026

(54) MOTOR

(71) Applicant: MINEBEA MITSUMI Inc., Kitasaku-gun, Nagano (JP)

(72) Inventor: Tomohisa SUZUKI, Kitasaku-gun, Nagano (JP)

(21) Appl. No.: 19/107,203

(22) PCT Filed: Aug. 25, 2023
(86) PCT No.: PCT/JP2023/030736

§ 371 Date: Feb. 27, 2025

(30) Foreign Application Priority Data
Sep. 15, 2022 (JP) 2022-147059

(51) Int. Cl. H02K 5/22; H02K 1/12

(52) U.S. Cl. CPC H02K 5/225; H02K 1/12

(57) ABSTRACT

There is provided a motor facilitating space-saving in a motor with a simple structure. A motor includes a plurality of rings formed of a conductive material and stacked in a rotation axis direction, and a stator including a plurality of coils. Each of the plurality of rings includes external connection terminals electrically connected to an external device, and internal connection terminals electrically connected to the plurality of coils. In a radial direction, the external connection terminals are disposed at an inner peripheral side with respect to the internal connection terminals.

### TECHNICAL FIELD

The present invention relates to a motor.

### BACKGROUND ART

Conventionally, in a motor, a bus bar is used as a member interposing between a lead wire from a coil and a conducting wire connected to an external power source or a circuit board to supply a large amount of current to the lead wire (see, for example, Patent Literature 1).

### CITATION LIST

### Patent Literature

Patent Literature 1: JP 2002-171708 A

### SUMMARY OF INVENTION

### Technical Problem

In using a bus bar, an increase in the number of coils requires a plurality of wiring circuits, and the wiring design tends to become more complex, for example. As a result, the space occupied by the bus bar in the motor increases.

An example of an object of the present invention is to provide a motor facilitating space-saving in the motor with a simple structure.

### Solution to Problem

The above-mentioned problem is solved by one aspect of the present invention described below, for example. A motor according to an aspect of the present invention includes a plurality of rings formed of a conductive material and stacked in a rotation axis direction; and a stator including a plurality of coils. Each of the plurality of rings includes external connection terminals electrically connected to an external device, and internal connection terminals electrically connected to the plurality of coils, and in a radial direction, the external connection terminals are located at an inner peripheral side with respect to the internal connection terminals.

### BRIEF DESCRIPTION OF DRAWINGS

FIG. 1 is a perspective view schematically illustrating an external appearance of a motor according to an embodiment of the present invention.

FIG. 2 is a longitudinal cross-sectional view of a motor according to an embodiment of the present invention, and corresponds to an A-A cross-sectional view in FIG. 1.

FIG. 3 is a transverse cross-sectional view of a motor according to an embodiment of the present invention, and corresponds to a B-B cross-sectional view in FIG. 1.

FIG. 4 is a perspective view schematically illustrating an internal structure of a motor according to an embodiment of the present invention, in a state with a housing removed from the motor.

FIG. 5 is an exploded perspective view of a bus bar unit schematically illustrating a structure of the bus bar unit integrated into a motor according to an embodiment of the present invention.

FIG. 6 is a plan view schematically illustrating a structure of a bus bar ring constituting a bus bar unit.

FIG. 7 is a plan view schematically illustrating a structure of a bus bar unit in a state with a lid removed from a bus bar unit.

FIG. 8 is a plan view schematically illustrating a structure of a bus bar unit integrated into a motor according to an embodiment of the invention.

### DESCRIPTION OF EMBODIMENTS

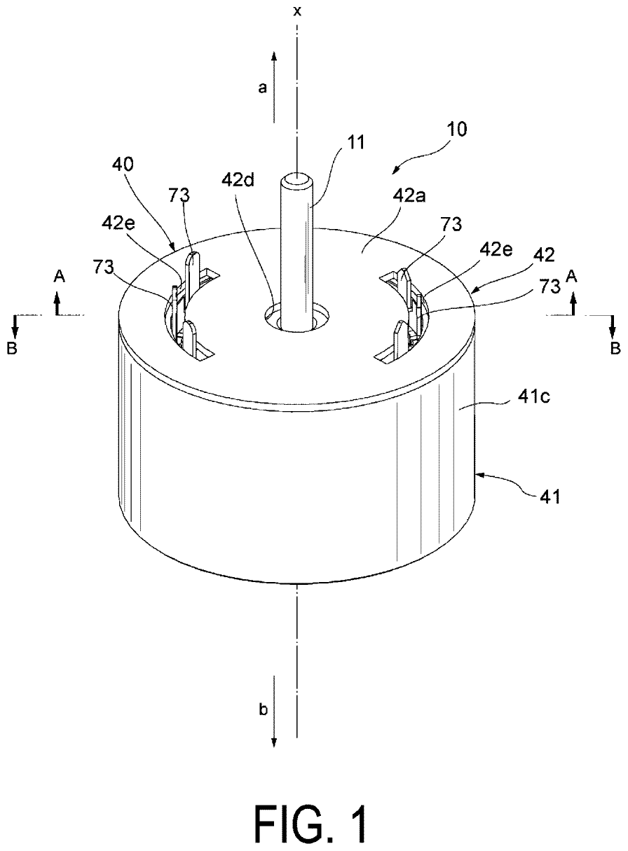

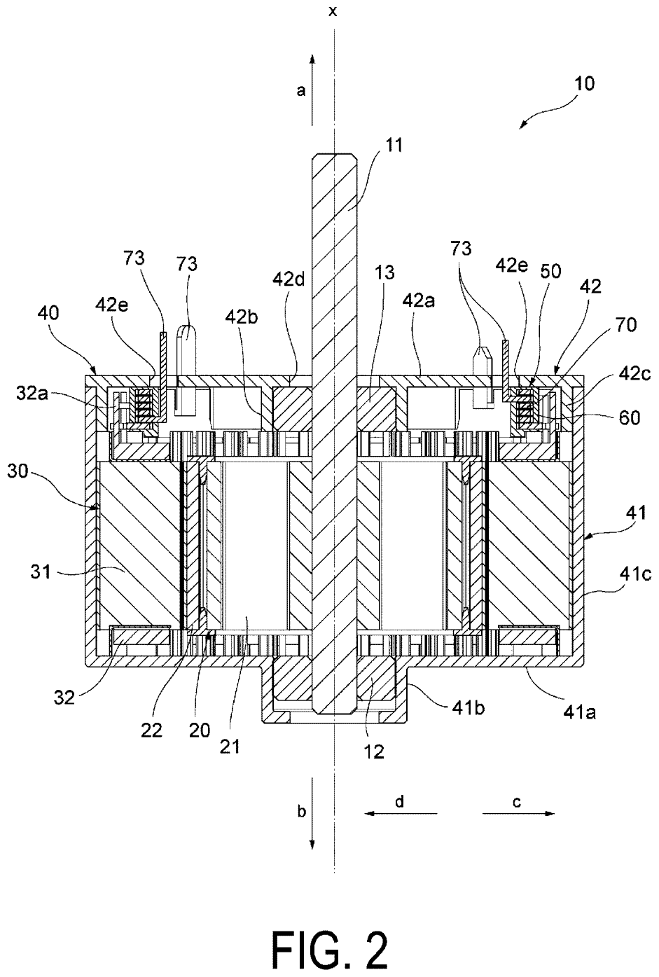

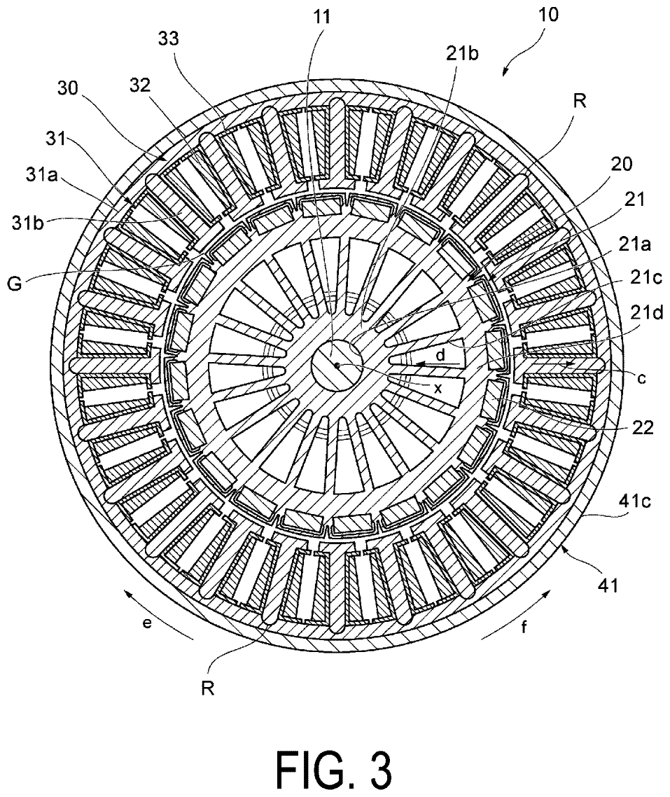

In the following, a motor of the present invention will be described, taking an embodiment and referring to the drawings. FIG. 1 is a perspective view schematically illustrating a structure of a motor 10 according to an embodiment of the invention, FIG. 2 is a longitudinal cross-sectional view of the motor 10, and FIG. 3 is a transverse cross-sectional view of the motor 10. Here, FIG. 2 corresponds to an A-A cross-sectional view of FIG. 1 along a hypothetical plane including an axis line x constituting a rotation axis center of the motor 10, and FIG. 3 corresponds to a B-B cross-sectional view of FIG. 1 along a hypothetical plane orthogonal to the axis line x.

In the description of the present embodiment, a side of a direction of an arrow a is defined as an upper side a, and a side of a direction of an arrow b is defined as a lower side b, in an axis line X direction (see FIGS. 1 and 2). Here, the upper side a and the lower side b do not necessarily match the vertical relation in the direction of gravity. Additionally, in radial directions c and d of the motor 10 perpendicular to the axis line x, a side in a direction of an arrow c heading away from the axis line x is defined as an outer peripheral side c and a side in a direction of an arrow d heading toward the axis line x is defined as an inner peripheral side d (see FIGS. 2 and 3). Furthermore, in peripheral directions e and f around the axis line x, there are defined a clockwise direction e and a counterclockwise direction f seen from the upper side a (see FIG. 3).

As illustrated in FIGS. 1 to 3, the motor 10 according to the present embodiment includes a shaft 11 that constitutes a rotation axis, a rotor 20 that is fixed to the shaft 11 and rotates together with the shaft 11, a stator 30 that is disposed so as to surround the rotor 20, and a housing 40 that is fixed to the stator 30 and accommodates some or all of the components of the motor 10. In other words, the shaft 11 and the rotor 20 rotate relative to the housing 40 and the stator 30 fixed to an external device (not illustrated) integrated with the motor 10.

The rotor 20 includes a magnet 22 disposed in a rotor core 21 formed of a magnetic material. The stator 30 includes a coil 32 wound around a stator core 31 formed of a magnetic material, and is fixed to the housing 40. Being a type of inner rotor brushless motors, the motor 10 according to the present embodiment is a motor referred to as an IPM motor. An IPM motor includes the magnet 22 embedded in the rotor core 21 and is also referred to as an embedded magnet-type motor.

The housing 40 includes a housing body 41 having a tubular shape opened at the upper side a and closed at the lower side b, and a cover 42 covering the opening of the upper side a of the housing body 41. The housing body 41 includes a bottom part 41a having an annular shape, a protruding part 41b protruding, in a tubular shape, from an inner peripheral edge of the bottom part 41a toward the lower side b, and an outer peripheral part 41c extending, in a tubular shape, from an outer peripheral edge of the bottom part 41a toward the upper side a. The stator 30 is fixed to an inner peripheral surface of the outer peripheral part 41c.

On the other hand, the cover 42 includes a flat plate part 42a having an annular shape, a protruding part 42b adjacent to an inner peripheral edge of the flat plate part 42a and protruding, in a tubular shape, toward the lower side b, and an outer peripheral part 42c adjacent to an outer peripheral edge of the flat plate part 42a and protruding, in a tubular shape, toward the lower side b. The outer peripheral part 41c of the housing body 41 and the outer peripheral part 42c of the cover 42 are fit and secured (fastened) together to complete the housing 40. The entirety of the rotor 20 and the stator 30 is accommodated inside the housing 40.

As illustrated in FIG. 1, the flat plate part 42a of the cover 42 is provided with a circular opening part 42d at the center of the flat plate part 42a, and a pair of opening parts 42e and 42e surrounding the opening part 42d. The shaft 11 protrudes from the opening part 42d toward the upper side a. The opening parts 42e and 42e extend around the axis line x in the peripheral direction. Referring to FIG. 2, the shaft 11 is rotatably supported by two bearings 12 and 13 fixed to the housing 40. One bearing 12 is attached inside the protruding part 41b of the housing body 41 and the other bearing 13 is attached inside the protruding part 42b of the cover 42 by press fitting, for example.

In the rotor 20, the rotor core 21 is formed of a stacked body of a plurality of magnetic materials stacked in the axis line x direction. As particularly illustrated in FIG. 3, the rotor core 21 includes a hole part 21a, an inner peripheral part 21b having an annular shape, a plurality of spokes 21c radially formed from the outer peripheral surface of the inner peripheral part 21b toward the outer peripheral side c, and an outer peripheral part 21d having an annular shape connecting outer peripheral ends of the plurality of spokes 21c. The shaft 11 is inserted in and fixed to the hole part 21a of the rotor core 21. The outer peripheral part 21d includes the plurality of magnets 22 embedded in the outer peripheral side c.

On the other hand, in the stator 30, the stator core 31 is formed of a stacked body of magnetic materials such as silicon steel sheets. The stator core 31 includes an annular part 31a disposed at the outer peripheral side c and a plurality of magnetic pole parts 31b formed so as to extend from the annular part 31a toward the inner peripheral side d. The plurality of magnetic pole parts 31b can be split from the annular part 31a by a boundary line R defined along base end parts of the plurality of magnetic pole parts 31b defined on the outer peripheral side d. In other words, the stator core 31 is a split core. An end part of the inner peripheral side d of the magnetic pole part 31b extends toward both sides in the peripheral directions e and f.

A coil 32 is wound around each of the plurality of magnetic pole parts 31b. An insulator 33 formed of an insulating material interposes between the stator core 12 and the coil 32. The insulator 33 insulates the stator core 31 and the coil 32. As illustrated in FIG. 2, one lead wire 32a, for example, is drawn from each coil 32. The lead wire 32a rises toward the upper side a. Via the lead wire 32a, electric current is supplied to the coil 32 or electric current is drawn from the coil 32. In the present embodiment, the number of the magnets 22 and the coils 32 is twenty four.

In the radial directions c and d, the end part of the magnetic pole part 31b of the stator core 31 opposes the magnet 22 of the rotor core 21 via a magnetic gap G. When electric current is supplied to the coil 32 of the stator 30, interaction with a magnetic field generated by the magnet 22 of the rotor 20 causes the rotor 20 to rotate about the axis line x. The shaft 11 attached to the rotor 20 can thus rotate relative to an external device (not illustrated) attached to the stator 30 and the housing 40.

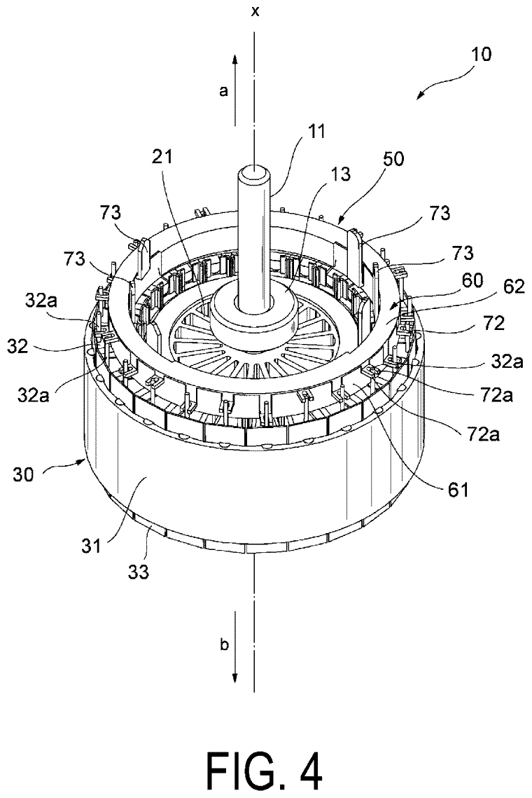

FIG. 4 is a perspective view schematically illustrating an internal structure of the motor 10 in a state with the housing 40 removed from the motor 10. Referring to FIGS. 2 and 4 together, the motor 10 includes a bus bar unit 50 having an annular shape accommodated in the housing 40 between the cover 42 of the housing 40 and the stator 30. The bus bar unit 50 electrically connects an external device (not illustrated) to the coil 32. A large amount of current, for example, can thus be supplied to each coil 32 through the bus bar unit 50.

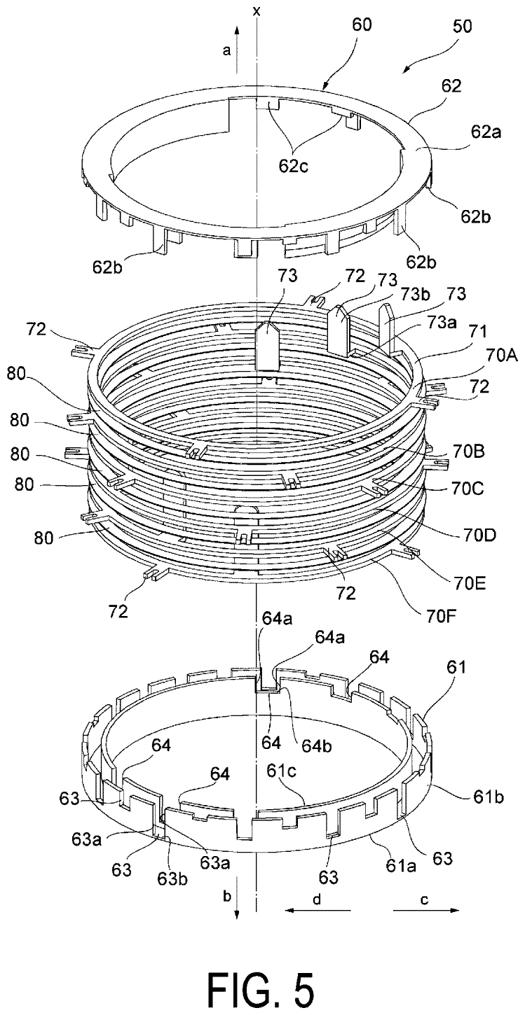

FIG. 5 is an exploded view schematically illustrating the structure of the bus bar unit 50 according to one specific example. Referring particularly to FIGS. 4 and 5 together, the bus bar unit 50 includes a case 60 having a tubular shape, a plurality of bus bar rings 70A to 70F stacked in the axis line x direction within the case 60, and an insulating member 80 disposed between two adjacent bus bar rings 70 and 70 in the axis line x direction. In the present embodiment, six bus bar rings 70A to 70F and five insulating members 80, for example, are alternately stacked in the axis line x direction.

Each of the bus bar rings 70A to 70F is formed of a conductive material including metallic materials such as copper and aluminum. Each of the bus bar rings 70A to 70F includes a ring body 71, one or more internal connection terminals 72 protruding from the inner peripheral side d toward the outer peripheral side c of the ring body 71, and one external connection terminal 73 protruding from the outer peripheral side c toward the inner peripheral side d of the ring body 71. The ring body 71 is formed of a flat annular member expanding across a virtual plane orthogonal to the axis line x. As is apparent from FIG. 5, in the plurality of bus bar rings 70A to 70F, the external connection terminal 73 is disposed at the inner peripheral side with respect to the plurality of internal connection terminals 72 in the radial directions c and d.

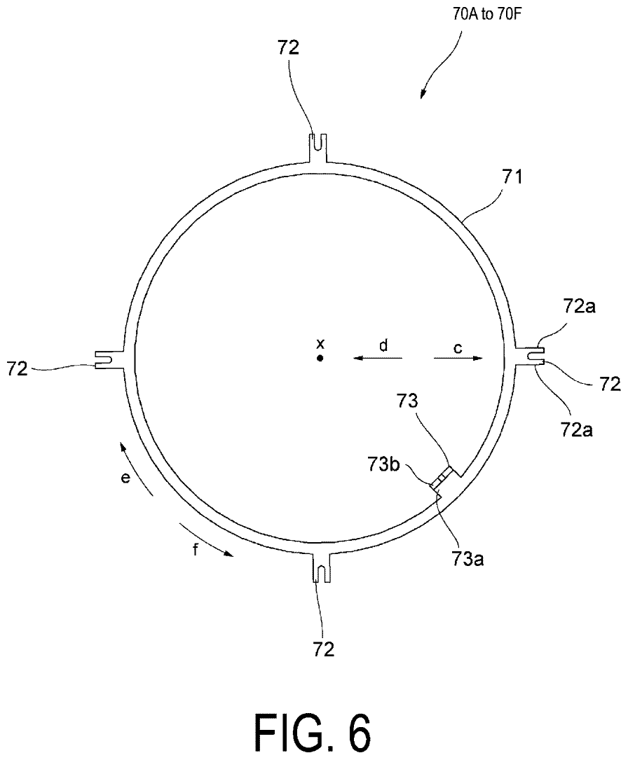

FIG. 6 is a plan view schematically illustrating the structure of the bus bar rings 70A to 70F according to one specific example. Also referring to FIG. 6, each internal connection terminal 72 protrudes from an outer peripheral end of the ring body 71 toward the outer peripheral side c in the radial directions c and d within a virtual plane with the ring body 71 expanding. Each internal connection terminal 72, being a fork-shaped terminal, includes a pair of terminal arms 72a and 72a extending in parallel with each other in the radial directions c and d. As is apparent from FIG. 4, each internal connection terminal 72 accommodates the lead wire 32a of the coil 32 between the pair of terminal arms 72a and 72a, and is electrically connected to the lead wire 32a.

In the present embodiment, each bus bar ring 70A to 70F includes, for example, four internal connection terminals 72 at an equal angular interval of 90 degrees. Because the bus bar unit 50 includes six bus bar rings 70A to 70F, the bus bar unit 50 includes a total of twenty four internal connection terminals 72. With regard to each of the bus bar rings 70A to 70F, the number and the intervals of the internal connection terminals 72 are unified. In other words, with regard to each of the bus bar rings 70A to 70F, the shape of the ring body 71 and the internal connection terminals 72 are equal to each other.

On the other hand, the bus bar unit 50 includes one external connection terminal 73 for each of the bus bar rings 70A to 70F, i.e., six external connection terminals in all. Each external connection terminal 73 includes, for example, a part 73a extending from the inner peripheral end of the ring body 71 toward the inner peripheral side d in the radial directions c and d (hereinafter referred to as a protruding piece 73a protruding toward the inner peripheral side d) and a part 73b extending from the inner peripheral end of the protruding piece 73a toward the upper side a (hereinafter referred to as a protruding piece standing upright on the upper side a). The protruding piece 73a protrudes from the inner peripheral end of the ring body 71 in the virtual plane with the ring body 71 expanding. The protruding piece 73b is formed of a plate piece expanding across a virtual plane expanding in parallel with the axis line x direction. The protruding pieces 73a and 73b form an external connection terminal having a bent shape. In the present embodiment, the external connection terminal 73 is disposed at an equal distance from two adjacent internal connection terminals 72 in the peripheral direction. In addition, the plurality of external connection terminals 73 are formed in a plurality of predetermined regions in the peripheral direction, forming a so-called plurality of groups.

As is apparent from FIG. 4, in the bus bar unit 50, three external connection terminals 73 are disposed at one side across the shaft 11, whereas three external connection terminals 73 are disposed at the other side across the shaft 11. As illustrated in FIGS. 1 and 2, the three external connection terminals 73 on one side protrude from one opening part 42e of the cover 42a toward the upper side a into the external space of the motor 10. On the other hand, the three external connection terminals 73 on the other side protrude from the other opening part 42e of the cover 42a toward the upper side a into the external space of the motor 10. The external connection terminals 73 are thus to be electrically connected to an external device (not illustrated).

Note that, in the present embodiment, the upper end of the protruding piece 73b of the external connection terminal 73 on one side has a linearly tapering shape toward the upper side a. On the other hand, the upper end of the protruding piece 73b of the external connection terminal 73 on the other side has a curved tapering shape toward the upper side a. As has been described above, with regard to each of the bus bar rings 70A to 70F, the shape of the ring body 71 and the internal connection terminal 72 are the same, whereas the external connection terminals 73 have two different shapes, and therefore the present embodiment is realized by using the bus bar ring 70 having two different types of shapes.

The insulating member 80 is formed of an annular member, for example, and has an annular and flat shape. The insulating member 80 is formed of an insulating material including a resin material, for example. The contour of the insulating member 80 seen from the upper side a matches the contour of the ring body 71 of the bus bar rings 70A to 70F seen likewise from the upper side a. Disposing the insulating member 80 between two bus bar rings 70 and 70 being adjacent to each other in the axial direction ensures insulation between the two bus bar rings 70 and 70.

Returning to FIG. 5, the case 60 includes a case body 61 forming an annular accommodation space, and a lid 62 covering the case body 61 in the axis line x direction so as to close the annular accommodation space. The case body 61 and the lid 62 are formed of an insulating material including a resin material. The case body 61 includes, for example, a bottom part 61a having an annular shape and expanding across a virtual plane orthogonal to the axis line x, an outer wall 61b having a cylindrical shape and rising from the outer peripheral edge of the bottom part 61a in the radial directions c and d toward the upper side a, and an inner wall 61c having a cylindrical shape and rising from the inner peripheral edge of the bottom part 61a in the radial directions c and d toward the upper side a. In the annular accommodation space of the case 60, there is accommodated a stacked body including the six bus bar rings 70A to 70F and the five insulating members 80.

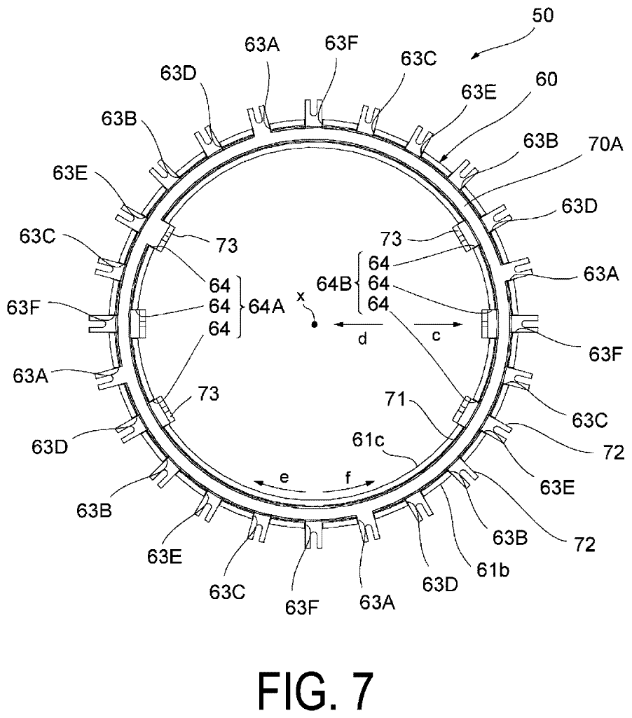

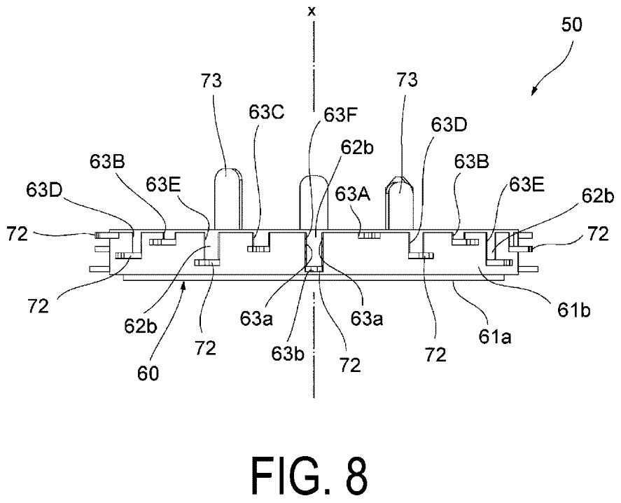

FIG. 7 is a plan view schematically illustrating the structure of the bus bar unit 50 in a state with the lid 62 removed from the bus bar unit 50 according to one specific example, and FIG. 8 is a side view schematically illustrating the structure of the bus bar unit 50 according to one specific example. Referring to FIGS. 4 to 8, a plurality of recess parts, i.e., slits 63 are formed at the outer wall 61b of the case 60. Each of the slits 63 corresponds to a plurality of internal connection terminals 72 of each of the bus bar rings 70A to 70F. The plurality of slits 63 are arranged in the peripheral directions e and f. Each slit 63 is a recess part recessed from the upper end toward the lower end of the outer wall 61b in the axis line x direction.

The internal connection terminals 72 respectively protrude from each of the slits 63 to the outer peripheral side c in the radial directions c and d. In the plurality of bus bar rings 70A to 70F, the plurality of internal connection terminals 72 are disposed at different positions from each other in the peripheral directions e and f. The plurality of internal connection terminals 72 and their corresponding plurality of slits 63 are disposed at an equal interval in the peripheral directions e and f. In the present embodiment, there are arranged twenty four internal connection terminals 72, so that the plurality of internal connection terminals 72 and the plurality of slits 63 are arranged at an equal angular interval of 15 degrees as illustrated in FIG. 7.

In particular, as illustrated in FIGS. 5 and 8, each slit 63 has a shape allowing reception of the internal connection terminal 72 into each slit 63 from the upper side a. Specifically, each slit 63 is formed by a pair of side edges 63a and 63a extending parallel to each other in the axis line x direction, and a bottom edge 63b extending along a virtual plane orthogonal to the axis line x. In the present embodiment, the bottom edge 63b of the slit 63 is configured so as to support a bottom surface of the internal connection terminal 72. However, there may be formed a gap between the bottom edge 63b and the bottom surface of the internal connection terminal 72.

As illustrated in FIGS. 7 and 8, the twenty four slits 63 form a total of 6 slit groups 63A to 63F, each one slit group corresponding to the internal connection terminals 72 of each of the 6 bus bar rings 70A to 70F. Each of the slit groups 63A to 63F includes four slits 63 arranged in the peripheral directions e and f at an equal interval of 90 degrees. The depth from the upper end of the outer wall 61b defined in the axis line x direction to the bottom edge 63b of the slit 63 of each slit group 63A to 63F is set so as to be different from each other for each of the bus bar rings 70A to 70F. Specifically, each depth to the bottom edge 63b of the slit 63 of each slit group 63A to 63F is set to one among a first depth to a sixth depth. The depth increases from the first depth toward the sixth depth. The difference between each of the depths corresponds to the thickness of one internal connection terminal 72 and one insulating member 80 in the axis line X direction.

For example, the four internal connection terminals 72 of the bus bar ring 70A disposed at the most upper side a in the axis line X direction protrude from each of the slits 63 of the slit group 63A having the first depth toward the outer peripheral side c. Similarly, respective internal connection terminals 72 of the bus bar rings 70B to 70F protrude from each of the slits 63 of the slit groups 63A to 63F having the second depth to the sixth depth, respectively, toward the outer peripheral side c. In the present embodiment, the slits are arranged at an angle interval of 15 degrees in the peripheral direction f in the order of: the slit group 63B with the second depth, the slit group 63E with the fifth depth, the slit group 63C with the third depth, the slit group 63F with the sixth depth, the slit group 63A with the first depth, and the slit group 63D with the fourth depth.

As illustrated in FIGS. 5 and 8, the lid 62 of the case 60 includes an annular part 62a extending in the peripheral directions c and d, and a plurality of protrude parts, i.e., protrude pieces 62b, extending from an outer peripheral edge of the annular part 62a toward the lower side b in the axis line x direction. The annular part 62a is a flat annular member expanding across a virtual plane orthogonal to the axis line x. The protrude piece 62b is formed at a position corresponding to the slit 63 of the case body 61 in the peripheral directions c and d.

In addition, the length of the protrude piece 62b from the annular part 62a in the axis line x direction is defined corresponding to the depth of the corresponding slit 63. Specifically, the length of the protrude piece 62b corresponds to the depth of the corresponding slit 63 minus the thickness of the internal connection terminal 72. Therefore, when the lid 62 is attached to the case body 61, each of the protrude pieces 62b of the lid 62 protrudes toward the corresponding slit 63 of the case body 61. As illustrated in FIG. 8, the slit 63 is closed by the internal connection terminal 72 and the protrude piece 62b.

On the other hand, as illustrated in FIGS. 5 and 7, the inner wall 61c of the case 60 is formed with a plurality of, i.e., six recess parts or slits 64. Each of slits 64 corresponds to the external connection terminal 73 of each of the bus bar rings 70A to 70F. Specifically, the six slits 64 forms slit groups 64A and 64B including three slits 64 respectively on one side and the other side with respect to the axis line x. In each of the slit groups 64A and 64B, the three slits 64 are arranged at an equal angular interval of 30 degrees in the peripheral directions c and d.

Each slit 64 has a shape allowing for receiving the external connection terminal 73 into each slit 64 from the upper side a. Specifically, each slit 64 defines a pair of side edges 64a and 64a extending parallel to each other in the axis line x direction, and a bottom edge 64b extending along a virtual plane orthogonal to the axis line x. In the present embodiment, the bottom edge 64b of the slit 64 is configured to support a bottom surface of the external connection terminal 73. However, there may be formed a gap between the bottom edge 64b and the bottom surface of the external connection terminal 73.

The depth to the bottom edge 64b of the slit 64 from the upper end of the inner wall 61c defined in the axis line x direction is set so as to be mutually different for each of the bus bar rings 70A to 70F. Specifically, the depth to the bottom edge 64b of each of the slits 64 corresponds to the first depth to the sixth depth of the slits 63. In other words, the external connection terminal 73 of each of the bus bar rings 70A to 70F protrude toward the inner peripheral side d from each of the slits 64 respectively having the first depth to the sixth depth. Here, the position of the slits 64 in the peripheral directions c and d is set to a position corresponding to the positional relation of the internal connection terminals 72 and the external connection terminals 73 for the bus bar rings 70A to 70F.

As illustrated in FIG. 5, the lid 62 of the case 60 includes a plurality of protrude parts, i.e. protrude pieces 62c, extending from an inner peripheral edge of the annular part 62a toward the lower side b in the axis line x direction. The protrude piece 62c is formed at a position corresponding to the slit 64 of the case body 61 in the peripheral directions c and d. In addition, the length of the protrude piece 62c from the annular part 62a in the axis line x direction is defined corresponding to the depth of the corresponding slit 64. Specifically, the length of the protrude piece 62c corresponds to the depth of the corresponding slit 64 minus the thickness of the external connection terminal 73. Therefore, when the lid 62 is attached to the case body 61, each of the protrude pieces 62c of the lid 62 protrudes toward the corresponding slit 64 of the case body 61. As such, the slit 64 is closed by the external connection terminal 73 and the protrude piece 62c.

In the motor 10 as described above, the external connection terminal 73 is located at the inner peripheral side d with respect to the internal connection terminal 72 in each of the bus bar rings 70A to 70F of the bus bar unit 50. As a result, it is possible to distribute the positions of the internal connection terminals 72 and external connection terminals 73 in the radial directions c and d, in comparison with the case where, for example, the internal connection terminals 72 and the external connection terminals 73 are arranged in the peripheral direction. Therefore, space saving in the motor 10 can be achieved with a simple structure. Furthermore, since the bus bar unit 50 has a stacked structure of a plurality of bus bar rings 70A to 70F, a simplified work is sufficient to form a plurality of circuits. In addition, owing to the simplified structure, it is possible to suppress increase of the manufacturing cost of the motor 10.

When manufacturing the bus bar unit 50 according to one specific example, the bus bar ring 70F is accommodated in the accommodating space of the case 60 while aligning the four internal connection terminals 72 of the bus bar ring 70F with the slit group 63F at the outer wall 61b. Subsequently, the insulating member 80 is disposed on or above the bus bar ring 70F. As such, the bus bar rings 70E to 70A and the insulating members 80 are alternately stacked. Because the depth of the slit 64 is set so as to be different for each of the bus bar rings 70A to 70F, the positions of the bus bar rings 70A to 70F can be easily located. The bus bar unit 50 is thus manufactured.

Here, although the above-described bus bar unit 50 has been explained taking an example having twenty four internal connection terminals 72 so as to correspond to twenty four coils 32, the number of the internal connection terminals 72 and the number of bus bar rings 70 can be set as appropriate in accordance with the number of coils 32. It suffices to set the number and positions of the slits 63 of the case 60 in accordance with the number set as described above.

In addition, the configuration of the motor 10 other than the bus bar unit 50 is not limited to the configuration of the above-described embodiment, and the present invention can be applied to any type of motor. Therefore, although the above-described embodiment takes an inner rotor-type motor as an example, the present invention can also be applied to an outer rotor-type motor, and can be applied not only to a brushless motor but also to a brush motor. In addition, the motor according to the present invention can be appropriately modified by a person skilled in the art according to known knowledge in the past. Such modifications are of course included in the scope of the present invention as long as these modifications still include the configuration of the present invention.

### REFERENCE SIGNS LIST

10 . . . Motor, 11 . . . Shaft, 12 . . . Bearing, 13 . . . Bearing, 20 . . . Rotor, 21 . . . Rotor core, 21a . . . Hole, 21b . . . Inner peripheral, 21c . . . Spoke, 21 d . . . Outer peripheral part, 22 . . . Magnet, 30 . . . Stator, 31 . . . Stator core, 31a . . . Annular part, 31b . . . Magnetic pole part, 32 . . . Coil, 32a . . . Lead wire, 33 . . . Insulator, 40 . . . Housing, 41 . . . Housing body, 41a . . . Bottom part, 41b . . . Protruding part, 41c . . . Outer peripheral part, 42 . . . Cover, 42a . . . Flat plate part, 42b . . . Protruding part, 42c . . . Outer peripheral part, 42d . . . Opening part, 42e . . . Opening part, 50 . . . Bus bar unit, 60 . . . Case, 61 . . . Case body, 62 . . . Lid, 61a . . . Bottom part, 61b . . . Outer wall, 61c . . . Inner wall, 63 . . . Recess part (slit), 63A to 63F . . . Slit group, 63a . . . Side edge, 63b . . . Bottom edge, 62a . . . Annular part, 62b . . . Protrude part (protrude piece), 62c . . . Protrude part (protrude piece), 64 . . . Recess part (slit), 64A and 64B . . . Slit group, 64a . . . Side edge, 64b . . . Bottom edge, 70A to 70F . . . Bus bar ring, 71 . . . Ring body, 72 . . . Internal connection terminal, 72a . . . Terminal arm, 73 . . . External connection terminal, 73a. . . Protruding piece, 73b . . . Protruding piece, 80 . . . Insulating member

1. A motor comprising:
a plurality of rings formed of a conductive material and stacked in a rotation axis direction; and
a stator including a plurality of coils, wherein
each of the plurality of rings includes external connection terminals electrically connected to an external device, and internal connection terminals electrically connected to the plurality of coils, and
in a radial direction, the external connection terminals are located at an inner peripheral side with respect to the internal connection terminals.

2. The motor according to claim 1, wherein, in the rotation axis direction, an insulating member is disposed between adjacent rings of the plurality of rings.

3. The motor according to claim 1, wherein, in the plurality of rings, the internal connection terminals are disposed at different positions from each other in a peripheral direction.

4. The motor according to claim 1, comprising a case accommodating the plurality of rings, wherein
the case includes a case body including an outer wall disposed at an outer peripheral side of the plurality of rings in the radial direction,
the outer wall includes a plurality of recess parts recessed in the rotation axis direction,
the plurality of recess parts are arranged in a peripheral direction, and
the internal connection terminals respectively protrude from each of the plurality of recess parts toward an outer peripheral side from an inner peripheral side of a ring of the plurality of rings.

5. The motor according to claim 4, wherein depths of the plurality of recess parts are different from each other.

6. The motor according to claim 4, wherein
each of the plurality of rings includes a plurality of the internal connection terminals, and
the plurality of internal connection terminals are disposed at equal positions, in a peripheral direction.

7. The motor according to claim 4, wherein at least shapes of two or more rings among the plurality of rings are equal.

8. The motor according to claim 4, wherein
the case body includes an inner wall disposed at an inner peripheral side of the plurality of rings, in the radial direction,
the inner wall includes a plurality of second recess parts recessed in the rotation axis direction, and
the external connection terminals respectively protrude from each of the plurality of second recess parts toward an inner peripheral side of the plurality of rings, in the radial direction.

9. A motor according to claim 8, wherein, in the rotation axis direction, depths of the plurality of second recess parts are different from each other.

10. The motor according to claim 4, wherein
the case includes a lid covering the case body in the rotation axis direction, and
the lid includes an annular part extending in a peripheral direction, and a plurality of protrude parts projecting from the annular part toward the plurality of recess parts.
